(19) United States
(12) Patent Application Publication
(10) Pub. No.: US 2011/0066444 A1
(43) Pub. Date: Mar. 17, 2011

(54) DIGITAL MARKETING AND REVENUE GENERATION METHOD AND SYSTEM

(76) Inventor: Aaron Fish, Vancouver (CA)

(21) Appl. No.: 12/949,575

(22) Filed: Nov. 18, 2010

Related U.S. Application Data
(63) Continuation-in-part of application No. PCT/CA2009/001005, filed on Jul. 17, 2009.
(60) Provisional application No. 61/135,110, filed on Jul. 18, 2008.

(51) Int. Cl. G06Q 30/00

(52) U.S. Cl. 705/1.1

(57) ABSTRACT

An Internet based digital marketing and revenue generator enables users to physically and digitally contribute value in exchange for entry, purchase, membership, services, etc. Users contribute value in the form of labor and data to the system by performing multiple work-related tasks, such as categorizing goods and services, inputting information, participating in surveys, in exchange for entry, which may include a prize draw entry to win one or more of the categorized goods and services. As well as including a prize draw entry, the system may provide a specified benefit, such as free admission, a free item, or other type of definite benefit, and/or a chance to win an additional prize(s).

This application is a continuation-in-part of and claims the benefit of PCT international application No. PCT/CA2009/001005, filed Jul. 17, 2009, which in turn claims the benefit of U.S. provisional application No. 61/135,110, filed Jul. 18, 2008. The disclosure of said PCT international application is hereby incorporated herein by reference thereto.

### TECHNICAL FIELD

The present invention relates to a digital marketing and revenue generation (DMRG) method and system.

### BACKGROUND

Technology is moving in the direction of providing corporations with direct communication with consumers and advanced consumer intelligence that more easily integrates with, adapts to, and complements their traditional and new media communications and marketing. In turn, corporations can produce marketing communications that are better tailored to connect with, educate and persuade consumers to purchase or consume more of a brand, product and/or service.

Regardless of how well advertisers communicate their costly marketing messages, however, consumers are still able to eliminate, ignore and/or skip such commercial content as advertisements embedded in traditional media (e.g., television, print media, and radio) or new media advertising formats, including online and mobile display/banner ads, search/pay-by-click methods, etc.

As a result, corporations are looking for a system that will leverage the benefits of new technologies while delivering higher rates of return on their marketing investment; generate new revenue streams from their digital content; achieve more direct communication with consumers and acquire more precise consumer intelligence; and engage consumers while constraining them to interact with and absorb their brand, product and/or service marketing messages.

### SUMMARY

The present invention is directed to a digital marketing and revenue generation method and system that increases the appeal, efficiency and effectiveness of traditional and new media advertising; creates one-on-one consumer/brand connections that lead to increased revenues and profitability; and delivers more advanced consumer intelligence by providing precise real-time consumer data, preference and permission consumer requests, and a pay-by-performance business application.

This digital marketing and revenue generation method and system can be easily adapted to suit any advertiser and digital media while providing content and activities that consumers actually want to engage with, absorb, and enjoy.

The method and system of the subject invention provides an electronic gate(s) made to enforce traffic of people in the digital world by restricting passage only to people who perform tasks, provide labor, input information, or similar. The electronic gateway is designed to display goods, services and survey questions in digital showrooms. To pass through the electronic gate(s), users must categorize goods and services and input research data as their “entry ticket, purchase, membership fee, etc”. Such an online gate may be used in a wide variety of digital settings including entertainment, social networks, search engines, rewards programs, contests, games, talent casting, mobile applications, memberships, research and marketing programs to name but a few.

Consumers may be given a choice of the way in which they enter an online club, social network, etc, or access digital content, or receive a product, publication or service etc. They may be given the choice to either pay for it or obtain it via one or more digital showrooms. If they pay for the benefit, then the money is electronically transferred to the entity providing the benefit. If they choose to obtain it through the digital showrooms, then the alliance of companies providing the prizes may then pay the entity providing the benefit.

Advertisers may be given a choice of the way in which they pay for direct one-on-one engagement with a consumer; “Pay for precision, preference, permission and performance” (P5) Marketing, enables advertisers to only pay for the precise demographic and data collected according to its quantity and quality. For example, permission given by a consumer to be called by the advertiser would be worth more than permission given to be emailed. As a result, the advertisers' marketing efforts can be highly focused and tailored towards the most receptive consumers.

One aspect of the present invention is a method of administering over a network of processing and communication devices exchanges of work for items and benefits, comprising presenting by a processor an assortment of items offered by at least one provider; receiving by the processor an assortment of work of value to the at least one provider; receiving by the processor a respective body of work performed by each of a plurality of workers, said respective body of work comprising an item choice selection from each of the plurality of workers; granting, by the processor, a benefit to each of the plurality of workers; and awarding to at least one of the plurality of workers, in response to his respective body of work, a selection of items corresponding to his respective choice.

Another aspect of the present invention is a method of administering over a network of computing and communication devices exchanges of work for prizes, comprising presenting by one or more of said devices an assortment of prizes offered by at least one sponsor, presenting by one or more of said devices an assortment of work of value to the at least one sponsor, receiving by one or more of said devices a respective prize choice selection from each of a plurality of workers, receiving by one or more of said devices a respective body of work performed by each of the plurality of workers, and awarding to at least one of the plurality of workers, in response to his respective body of work, a selection of prizes corresponding to his respective choice.

A further aspect of the present invention is a system for administering exchanges of work for prizes comprising a computer-readable medium, a processor in a server, a plurality of computing and communication devices connected via a network to said server, and computer-readable instructions residing in said computer readable medium for processing by said processor, the system being configured to present by the processor an assortment of prizes offered by at least one sponsor, present by the processor an assortment of work of value to the at least one sponsor, accept by the processor a respective prize choice selection from each of a plurality of workers, accept by the processor a respective body of work performed by each of the plurality of workers, and determine at least one of the plurality of workers to be awarded, in response to his respective body of work, a selection of prizes corresponding to his respective choice.

Still another aspect of the present invention is a system for publicizing sponsorship of an event comprising a computer-readable medium, a processor in a server, a plurality of remote terminals connected via the internet to said server, and computer-readable instructions residing in said computer readable medium for processing by said processor, the processor being configured to display information relating to a plurality of sets of items on a remote terminal, each set offered by a different provider; accept a plurality of first inputs from said remote terminal, each first input representing a selection of an item from each of the sets; display on said remote terminal, for each of the sets, one or more questions relating to the items in the set; accept from said remote terminal, for each of the sets, one or more second inputs representing responses to said questions relating to the items in the set; define the selected items as a prize package conditional upon receiving a second response for each of the sets; for each set, transmit information representative of said second inputs to the provider of the set; accept from said remote terminal an input from a user representing permission to be contacted by a first provider; transmit sufficient information to said first provider to enable said first provider to contact said user; and accept an input from said user representing an interest to receive a benefit related to said event.

Yet another aspect of the present invention is a system for administering exchanges of work for prizes comprising a processor and a plurality of terminals connected to the processor, the processor configured to present via the plurality terminals at least one prize offered by an provider; accept via each terminal a respective body of work each performed by one of a plurality of workers; categorize the bodies of work into categories of different value; provide one or more categorized bodies of work to the provider; receive from the provider a commitment to pay an amount depending on the value of each categorized body of work provided; and determine at least one of the plurality of workers to be awarded the prize.

Still another aspect of the present invention is a system for administering exchanges of work for predetermined benefits comprising a processor and a plurality of terminals connected to the processor, the processor configured to present via the plurality terminals an opportunity to work for a provider; accept via each terminal a respective body of work each performed by one of a plurality of workers; grant each worker a predetermined benefit; categorize the bodies of work into categories of different value; provide one or more categorized bodies of work to the provider; and receive from the provider a commitment to pay an amount depending on the value of each categorized body of work provided.

Also disclosed is a mobile processing and communication device for exchanging work for items and benefits, the device comprising a processor, a display and an input interface, the processor configured to present via the display an assortment of items offered by at least one provider; receive, via the interface, work of value to the at least one provider, said work comprising an item choice selection; transmit the work to a further, remote processor for storage in a computer readable medium; receive a benefit or access to a benefit; and receive confirmation of a chance to win a selection of items corresponding to said item choice selection.

This summary is provided to introduce a selection of concepts in a simplified form that are further described below in the Detailed Description. This summary is not intended to identify key or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a high level overview of the system (and method), its inputs and its outputs.

FIG. 2 shows a view of an embodiment of the system and a context in which it may be used.

FIG. 3 shows an exemplary embodiment of the hardware that is used in the system of the present invention.

FIG. 4 is a summary flowchart of an example embodiment of the electronic process of the system.

FIG. 5 shows the user process and data flow of the Choose Rewards and Registration modules

FIG. 6 is the user process and data flow of the IT Engine Report Selection module.

FIG. 7 shows the user process and data flow of the eBusiness and Qualified Lead Reception modules.

FIG. 8 shows the user process and data flow of a Presenter's Admin module.

### DETAILED DESCRIPTION

The following detailed description includes references to the accompanying drawings, which form a part of the detailed description. The drawings show, by way of illustration, specific embodiments in which the system and methods may be practiced. These embodiments, which are also referred to herein as “examples” or “options,” are described in enough detail to enable those skilled in the art of providing goods and services of any kind to practice the present invention. The embodiments may be combined, other embodiments may be utilized or structural or logical changes may be made without departing from the scope of the invention.

In this document, the terms “a” or “an” are used to include one or more than one, and the term “or” is used to refer to a nonexclusive “or” unless otherwise indicated. In addition, it is to be understood that the phraseology or terminology employed herein, and not otherwise defined, is for the purpose of description only and not of limitation.

### I. Glossary

The following definitions apply to the detailed description below and in relation to the figures.

User: It will be appreciated that as used herein the term “user” broadly refers to a person that provides labor and/or inputs data, to the computerized system. A user may be referred to as an individual, a consumer or a user of the system. A user may refer to an incorporated body that consumes goods and services provided by a provider. A user may be referred to as an internet user, a visitor or a member of the public and who interacts with the system via the internet, whether it is hardwired, wireless or mobile. A user may become a participant, online participant, contestant or entrant in a contest by entering or passing through the digital showrooms. A user may become a member of an online community by passing through the digital showrooms.

Consumer Intelligence: Information provided by users that may benefit one or more providers associated with the system.

Digital Showroom: It would be appreciated that as used herein the term “digital showroom” refers to the material (goods and services) display and questions that are contained within the digital marketing and revenue generation (DMRG) system. They are the online user/provider digital interfaces and exchange apparatus that enable providers to display goods, services and survey questions; and enable users to interact with as well as select goods and services, and input information and or survey answers.

Provider: An entity that provides the goods, services and survey questions in the digital showrooms. Such entities include one or more of a corporation, advertiser, advertising agency, sports league, sports franchise, production company, traditional media company, musician, band, entertainment company, government, partnership, club, association, new media company, other company, business, charity, and individual, although various other entities may benefit from the program. A provider may also include other providers of goods and services, such as brands, products, and prizes, or any other entity able to offer any of these. For example, a corporation (advertiser) may provide a brand that is produced by someone else. Furthermore, providers associated with the system may benefit from different aspects of a survey, research data and/or consumer intelligence collected by the system depending on the needs of the provider. As such the computerized system may be configured to offer the provider research data and/or consumer intelligence information that may be specific to their individual needs. The terms “corporate user”, “sponsor” and “corporate sponsor” may be used synonymously with “provider”. A corporate user may be someone employed, appointed or authorized by a provider, corporation, advertiser or other business entity.

Program: As used herein “program” refers to software or firmware components that may be executed by, or utilized by one or more computing devices of the computerized system, and is meant to encompass individual or groups of executable files, data files, libraries, drivers, scripts, database records, etc.

System or DMRG System: This generally refers to the technology disclosed herein, either in whole or in part. There are also subsystems, such as a proprietary software system. The system may include software, firmware, hardware, computing devices, communications networks, media networks, the internet, traditional, new and still-to-emerge media, entertainment devices and publications, programming, broadcasting and advertising signals, and other components, devices and/or features.

End-user: This refers to a user engaged in one or more of the modules of the software of the system, and the term is used when describing the functionality of a specific module. An end-user may be a provider or a user, depending on the module. An end-user generally makes use of the software of the system as written or set up, and generally has a limited selection of options for controlling the software.

Branded Items: These include products and services produced, supplied or provided by providers, where the provider wishes to advertise itself or its products and services. It includes items such as cars, televisions, holidays, houses, mortgage payments, cash prizes, or others.

Prize: Refers to an item such as a physical product, such as a car, or a service, such as insurance, a vacation, a sum of money, the right to decide how to spend a sum of money, a monthly online subscription, a video stream of a TV series, purchase of a feature film or mobile application, a software program, access to a sporting event, a coupon, an incentive, reward points, privileges, membership of a group, the opportunity to appear on a show, the right to enter a contest, an admission ticket to a concert, etc. A prize may be selected by a user or it may be predefined by others. A prize or selection of multiple prizes can be made by a user. An award and/or reward made to a user may correspond to the user's goods and services selection (prize selection) in full or in part.

Work or Labor: These have been used to describe the information, tasks and activities that users provide to the system. A body of work and/or labor may include one or more tasks, and may, for example, comprise inputting one's name, opinions on products or other goods, granting a license to use one's work or uploading a video clip. In relation to this, users may be described as workers.

Scenario: A scenario may refer to the setting in which prizes are offered. For example, a scenario may be a real-life situation, a plot, an event, an event that may be sponsored, a challenge, a contest, etc. A worker may also present a scenario as part of the body of work.

### II. Overview

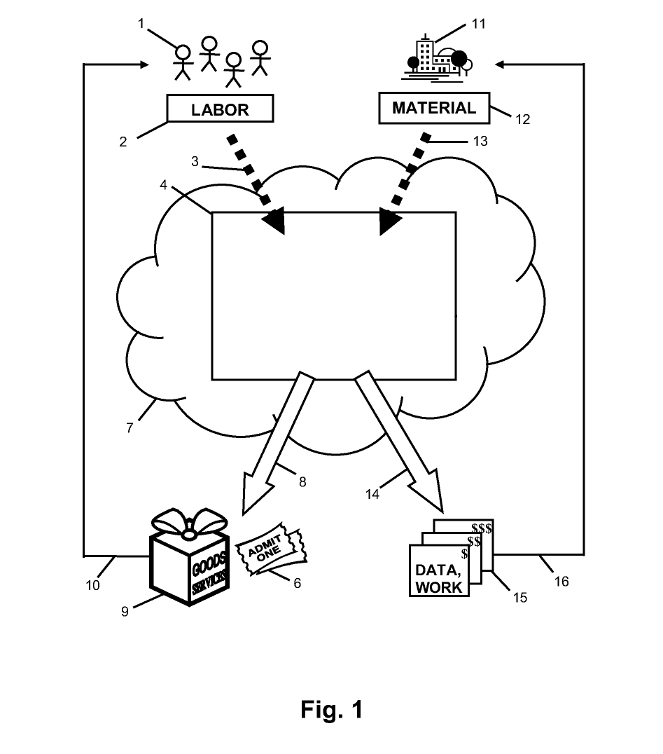

Referring to FIG. 1, there is shown a high level overview of a digital marketing and revenue generation (DMRG) system 4 (and method performed by using the system) in accordance with the present invention. As seen in FIG. 1, users 1 provide labour, and/or input preferences 2 into the DMRG system 4 to receive entry 6 and a chance of a prize or prizes 9. One or more providers 11 input images of material 12 into a series of digital showrooms contained in the DMRG system 4 and receive real-world data 15, which may be work product or may be in addition to work product. In other words, users 1 input 3 their labor 2 by inputting their real-world preferences and/or other tasks into the DMRG system 4, which effectively filters and outputs 14 a set of ordered work product and/or data 15 that is delivered 16 to a provider 11. Likewise, a provider 11 inputs 13 a representation of material 12, i.e. an assortment of real-world goods and/or brands, products and/or services, into the system 4, which makes them available and outputs 8 them as a set of categorized goods and/or brands, products and/or services 9 that may be won by one or more users 1, as well as enabling entry 6 or providing admission for users 1.

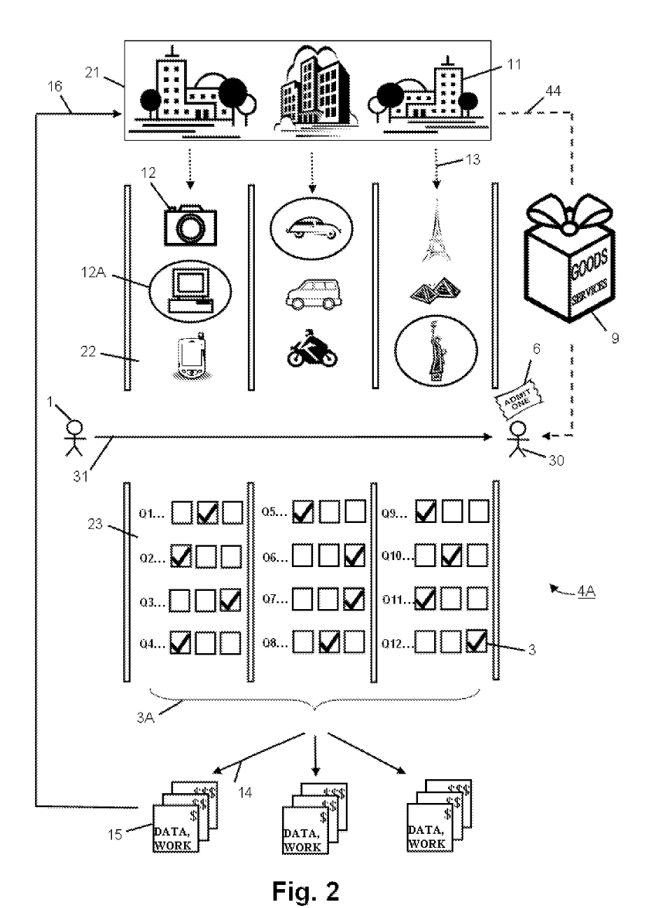

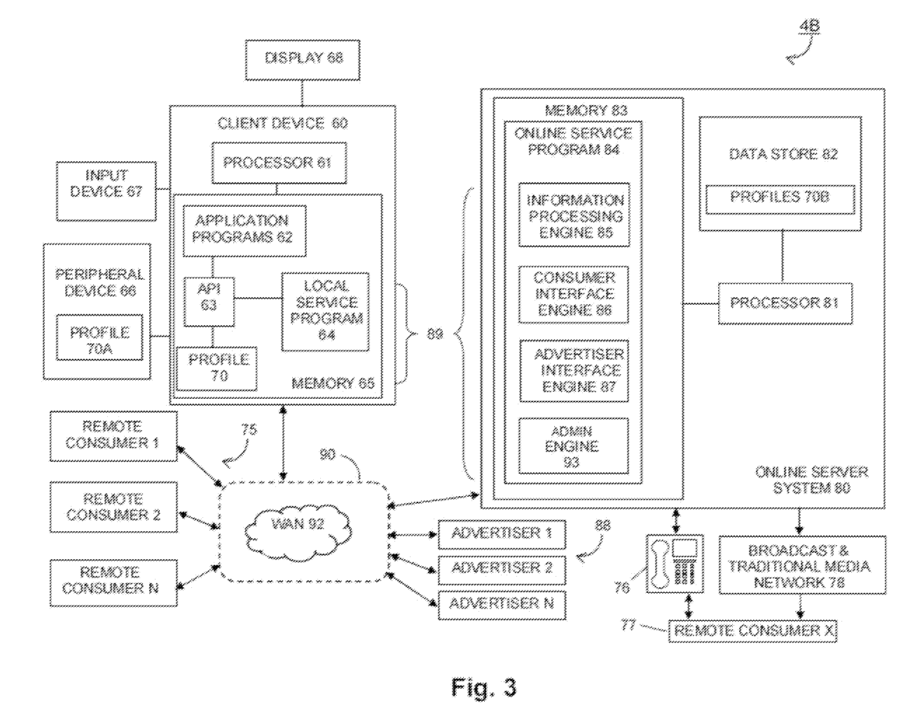

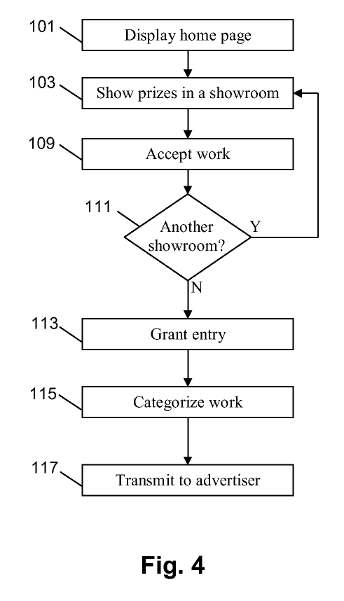

For the sake of simplicity, the following description relates to only one of many embodiments possible and is intended to introduce the key concepts. A DMRG system embodied in accordance with some aspects of the present invention desirably includes one or more or of (1) a provider, (2) a series of providers, (3) a display or other communication of goods and/or services and (4) an information processing engine. Some of these parts may be seen in FIG. 2, which also shows the interaction between the various contributors to the system and the system's stages that work in a series. Furthermore, FIGS. 3 and 4 respectively illustrate the hardware and the electronic process of the system.

### Alliance

The DMRG system 4A in FIG. 2 enables one or more providers to become a team and provide a series of showrooms 22 with goods and services 12 in an alliance 21. For example, there could be an alliance of three corporate providers. Since the providers are industry exclusive and/or product category exclusive, there is no competition between the alliance members 11. Users 1 armed with new technologies can use the DMRG system 4A, which is specifically designed to ensure users engage directly with providers and/or their goods and services in order to gain access. The alliance members 11 provide a wide range of goods/material and or services 12, 12A that engage users or labor force 1.

By sharing the cost of running digital showrooms in a DMRG system, the corporate alliance members invest a fraction of the price of supporting a comprehensive incentive and rewards-driven program.

### Digital Showrooms

The digital showrooms 22 connect users 1 with providers 11 and their assets 12.

Each provider 11 in the alliance 21 provides 13 and displays brands, products and/or services 12, in their own digital showroom 22 accessible via a web browser connected to the internet. Each provider may provide and display multiple brands, products, and/or services within their digital showroom, as well as various survey/service related questions 23 such as ones relating to product testing, receiving personal services, direct contact, etc.

Using the digital showrooms 22, providers 11 are enabled to introduce and market goods and services through a superior user experience that is transparent, attractive, engaging and meaningful to users' personal needs/lifestyles. As users “walk” through 31 the digital showrooms, they must perform at least one task, which may be to select at least one 12A of the showcased items 12 from each showroom as part of a categorization and collection 9. As an example, the user has selected a computer 12A from the first showroom, which also exhibits a camera and a mobile phone. The user has selected a car from the second showroom, and a trip to New York in the third showroom.

While within a particular showroom 22, the one task the users must perform may be to answer one or more questions 23 relating to that showroom's brands, products and/or services displayed. The users' answers 3 are collected 3A and categorized to provide 14 the provider with valuable information 15. For example, in a car showroom, users may request a phone call from the provider to arrange a test drive for a specific model of vehicle.

The digital showrooms offer providers the efficiency of paying for data 15 that has been selected 3A for users that have recently interacted with the provider's brands, products and/or services; categorized 12A an item relevant to the user's needs; input information, and/or selected additional information and/or services, such as to be contacted directly by the provider.

In addition to receiving 16 consumer intelligence 15 through the digital showrooms, the advertisers also create increased brand awareness through a one-on-one brand/consumer interaction process.

### Entry

After consumers at position 30 have completed their tour of the digital showrooms, they receive an entry, admission or a benefit 6, which may be access to a digital asset, rental of an item, purchase of an item, an entry in a contest, entry in prize draw, entry in a game, entry to a sports fantasy program, entry to a stock dealing fantasy program, entry to a club, membership of a community, admission to a show, admission to a concert, membership of an audience, a free download of music, a free download of an app, a free download of video, a printed publication, a coupon, one or more reward points, access to an online TV show, access to digital content, a discount, a password, a gift, a surprise gift, an improved rating, one or more reputation points, a cellular activation, cellular airtime, free communications bandwidth, a cable subscription, air miles, an increased chance in a prize draw, a sum of money, etc.

### III. Hardware

Referring now to FIG. 3, there is an exemplary embodiment of the computerized system 4B shown in greater detail. The computerized system 4B uses a user client device 60 comprising a processor 61 configured to execute one or more of a plurality of application programs 62 residing in memory 65, via an application programming interface (API) 63. Application programs 62 are configured to communicate marketing data for each of a plurality of users via an interactive service program 89 to an online server system 80. The interactive service program 89 is configured to store the marketing data in a profile 70 for each user. The data in profile 70 is made available to the plurality of different application programs 62 by the application programming interface 63 and the service program 89, which are configured to receive and process via read and write requests for the marketing data in the user profiles, from each of the application programs 62, as described in detail below.

It will be appreciated that the interactive service program 89 may include a local component and an online component. The local component may be a local service program 64 executed on the user client device 60, and the online component may be an online service program 84 residing in electronic memory 83 executed by the processor 81 in the online server system 80. The local component 64 may function as a subset of the online component functionality of the online service program 84 in the event that connectivity is not available. Alternatively, the local component may be a “thin client” (e.g. a Web browser) to which application software and services are communicated via the Internet. Whether the application programs are displayed on the user client device via a thin client, which is served remotely, or reside as standalone applications, they are described herein to be executed on the client device.

The profile 70 may be stored in the user client device 60, in a peripheral device 66 associated with the user client device 60 as illustrated at 70A, or on a data store 82 associated with the online server system 80, as illustrated at 70B. The user client device 60 and the online server system 80 are configured to communicate via a computer network 90, such as the internet, which may include a wide area network (WAN) 92. The application programs 62 of the user client device 60 may be configured to communicate over WAN 92 with the online service program 84 via the application programming interface 63 and local service program 64. In other embodiments, for example, the computer network 90 may be a wireless telephone network configured to communicate with computer-enabled wireless telephones or other mobile computing devices.

The user client device 60 may be a personal computer, computer-enabled wireless telephone, portable digital assistant (PDA), or other computing device on which a computer operating system is configured to interact with the application programs 62. The user client device 60 may include a processor 61 connected via a bus to memory 65, that is either volatile (e.g., Random Access Memory), non-volatile (e.g. Read Only Memory), and/or a mass storage device (e.g. a hard drive). The user client device 60 further may be configured to receive input from one or more of associated input devices 67, such as a keyboard, mouse, stylus, camera, game controller, and/or microphone, and to send output to output devices such as a display 68. It will be appreciated that these input and output devices may be integrated into the user client device 60, such as in a laptop or mobile telephone. The user client device 60 may also include various standard components not shown in FIG. 3.

As noted above, a peripheral device 66 equipped with a non-volatile storage for storing a copy of the profile 70A may also be provided. The peripheral device 66 may be, for example, a memory-equipped stylus, mouse, portable USB flash drive, etc., and may be configured to connect directly, or via a wired or wireless connection to the user client device 60.

The computerized system 4B further includes a plurality of other client devices connected to the computer network 90, such as remote user client devices 75. Like the user client device 60, each of the remote client devices is configured to run one or more of the application programs 62 and the local service program 64. As these devices are configured similarly to device 60, they will not be described in detail. It will be appreciated that the computer network 90 may further include a local area network (LAN), and local client devices connected to it may be configured to communicate with the user client device 60 via the LAN. The LAN may be a wireless or wired network.

Remote peer client devices 75 typically connect to WAN 92 of the computer network 90. It will be appreciated that the primary difference between local peer client devices and remote peer client devices is their respective point of contact with the computer network 90, and a single computing device, such as a portable laptop computer or web-enabled mobile telephone, may transition between network access points and alternately assume the role of locally and remotely connected peer device.

As mentioned above, the computerized system 4B may include the data store 82 configured to communicate with or be part of the online server system 80. The data store 82 may be configured to store data used by the online server system 80, including profiles 70, as discussed above and illustrated at 70B. The function of these data types is also described in detail below.

Providers 88 may interact with the online server system 80 using client devices such as that described at 60, except that a provider client device may not necessarily include a user profile 70.

Each of the local service program 64 and the online service program 84 also may include a variety of software engines configured to provide specific functionality. In the illustrated configuration, a version of one or more of the engines may be provided at each of the local service program and the online service program. The collection of software engines is illustrated to include an information processing engine 85, a user or consumer interface engine 86, a provider or advertiser interface engine 87 and an administration engine 93. These engines may be generally described without specifying a location, or may be specifically described by reference to the location of the engine as local or online. It will be appreciated that the engines may reside both locally and online, or may be provided at one or the other of the local service program or online service program. The function of each of the engines listed above will be described in detail below.

Other remote users such as shown at 77 may interact with the online server system via traditional methods. For example, a remote user or consumer 77 may receive communications from the online server system via a television or radio broadcast and traditional media network 78, or via a newspaper publisher. Branded items that may be potential prizes that would normally be displayed digitally may appear in printed publications such as newspapers or magazines. The processor 81 may transmit information relating to the display of the branded items to automated printing machinery that prints the publications. Such a user may provide communications back to the online server system via a traditional telephone system 76.

Processors 61 and 81 may each comprises constituent processors as well as other components to allow the constituent processors to communicate and operate effectively together. Multiple such constituent processors may be located together or separate from each other.

### IV. Functional Modules

The functional modules are presented in terms of block diagrams and flowcharts which show how the system operates, how it interacts with the various users, the users' perspectives of the system and how data is exchanged at different points with the main database of the system.

Referring now to FIG. 4, there is illustrated an exemplary embodiment of the basic functions of the system in FIG. 3. In step 101, the system causes a home page to be displayed via a web browser on a user's remote terminal, which could be a computer or smart phone, for example. A button is provided, or a link is provided on the home page, that when clicked by the user, causes the display of a set of one or more prizes in an online digital showroom 103. The system is configured to accept work input from the user defining either a choice of a prize from the set of prizes displayed, a response to one or more questions displayed, or both prize selection and responses. A user may respond to questions by entering text or checking boxes, for example. The system accepts 109 the user's work and then checks 111 whether there is another showroom to be visited. If there is another digital showroom that the user has not yet visited, the system reverts to step 103 and displays another set of prizes in another digital showroom. The process repeats the loop until all digital showrooms have been visited and the questions answered and/or other work performed. When there are no more digital showrooms to be visited by the user, the system grants entry 113 or assigns a privilege to the user. This may be the eligibility to win one or more of the selected prizes, the ability to enter one or more contests, the eligibility to join a group or a community, or anything else that may be beneficial to the user. The system categorizes the responses 115, and, together with responses from other users that use the system, transmits 117 the responses to the providers who are presenting the prizes in the digital showrooms.

The various functions as described in FIG. 4 can be combined or divided into modules in many different ways when implementing the system. For example, functions 101, 103, 109 and 111 may be embodied in modules in the user interface engine 86 for choosing rewards and registering, described below. Function 113 may also be embodied the user interface engine 86 by step 172 described below. Function 115 may be embodied in the information processing engine 85, and function 117 may be embodied in provider's admin module present in the admin engine 93. Further modules may be added to facilitate the interoperability of those already mentioned.

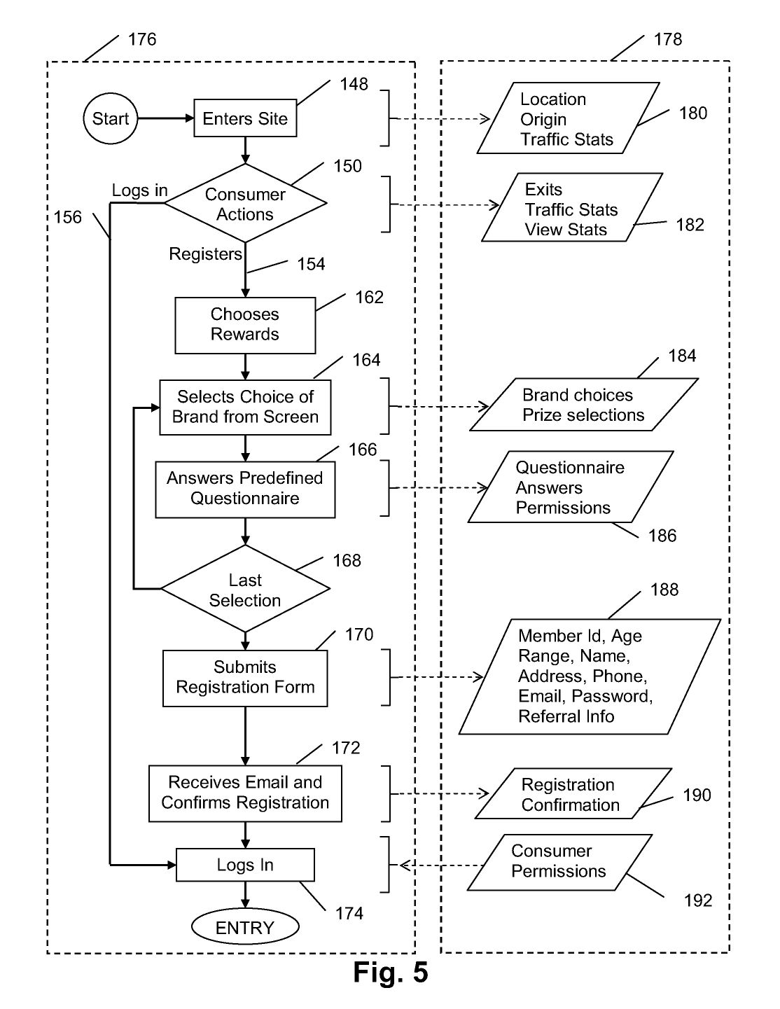

FIG. 5 shows the end-user process and data flow of modules in the user interface engine 86 for choosing rewards and registering. FIG. 5 is an integrated diagram of the user process box 176 and data flow box 178 involved in choosing rewards and registering. FIG. 5 illustrates the interactive process from an online user's perspective, and the dynamic data flow between the user's activity and the database of the DMRG system.

Users begin the online interactive experience by entering the branded home page or site 148 of the provider or alliance of providers (or various other branded landing pages, as noted in FIG. 5). A home page theme, content and design may vary according to the provider's online and/or traditional marketing elements. The home page 148 may include such content as a welcome message and links to a login section, a user registration process, and additional content. This page inputs data into the database about the user's originating URL, IP location, time of entry, and other generic website traffic statistics 180. Data from all actions are tracked by the system, measuring exits and other generic website visitor statistics 182.

For users that have already registered, from the introductory page, they may choose 150 to login to the system 156, 174 (i.e., this action is dependent on user status as registered). The system detects 192, from the login and password, that the user has been authorized for entry into whatever the digital showrooms provide access to.

For users that have not already registered, from the introductory page, they may choose 150 to register to the system 154 (i.e., this action is dependent on user status as non-registered). Users register, for example, if they wish to participate in contests offered by entering or after passage through the digital showrooms.

The first stage of the registration process involves “playing” an interactive online game, or activity: “Choose Your Own Rewards” 162. The game consists of various digital showrooms or brand galleries hosted by industry exclusive and/or product category exclusive providers offering multiple choices of rewards that users select from 164.

Included in each digital showroom is a questionnaire section that displays several multiple-choice questions, ranging in scope, that users answer 166. These questions are derived from the marketing goals of the providers. Data regarding brand selection 184, questionnaire answers, and “opt-in” permission to be contacted is saved in the system database 186.

Upon completion of the digital showroom tasks 168, users will have categorized items of preferred brands, products and/or services and completed a survey.

The second stage of the registration process involves entering information into and submitting a registration form 170. The registration form sends basic profile information such age range, name, address, phone, email and password to the database 188.

Once the registration form is submitted, an email is automatically sent to the email address entered in the registration form. When the registering user receives the email, and clicks a link contained in it 172, the entry login page loads in a web browser 174, and data regarding the completion of the registration process is sent to the system database 190.

The registered user may now login for the first time. The system detects 192, from the login and password, that the user has authorized access to entry.

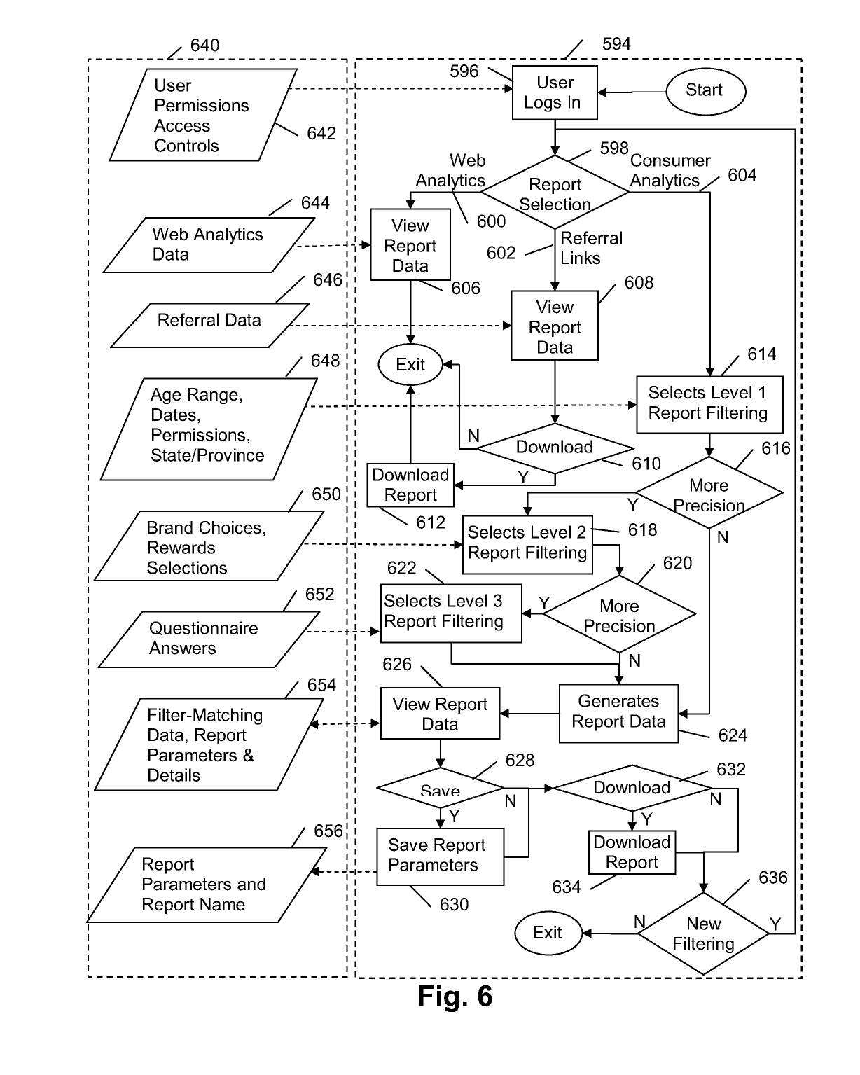

FIG. 6 shows the end-user process and data flow of the information processing engine 85. FIG. 6 is an integrated diagram of a provider's (or advertiser) perspective of the information processing engine 85. This module is the main engine of the software and is not meant for use by the public. This diagram assumes that the provider using the information processing engine 85 is an authorized individual of the provider or alliance of providers.

Box 594 contains the user interfaces of the reporting functions of the proprietary software. Box 640 contains the data stored in the database of the information processing engine 85, which is essentially the same data collected from the processes previously identified in FIG. 5.

The provider begins by logging into the system 596. The system detects, from the login and password that the provider has authorized access to data input by the users 642.

The provider then has access to multiple analytics reports 598, each of which collate data from the system database. These reports may include web analytics, referral links, or others. FIG. 6 illustrates the provider flow for three of these reports.

If the provider selects the web analytics report 600, the report's data is retrieved from the system database 644, collated by the system, and then displayed within a web page 606. The report includes such industry standard pieces of information as total number of visits, unique visitors, returning visitors, etc. The provider can then choose to exit the system or select other reports.

If the provider selects the referral links report 602, the report's data is retrieved from the system database 646, collated by the system, and then is displayed within a web page 608. The report includes inbound referral activity across referral links associated with the provider. If the provider accessing the report is a specific provider, the database only delivers referral data associated with the provider in question. If the report is accessed by a provider of the corporate alliance they can select which provider's referral data will be represented in the report. The provider can then choose 610 to download the report's data in various file formats (e.g., PDF, HTML, tab delimited, plain text) 612, exit the system, or select other reports.

If the provider selects the user analytics report 604, the report functions begin 614 with the first of three report filtering levels to choose from: Level 1, Level 2 and Level 3. Each filtering level offers an increasing degree of data-filtering precision. For example, a Level 1-filtered report may be based upon parameters with respect to “location” and “age range” for the users represented in the report, as delivered by the system database 648; a Level 2-filtered report, in addition to the Level 1 filter parameters, may be further based upon parameters with respect to the users' brand/services selections, as delivered by the system database 650; and a Level 3-filtered report, in addition to the Level 1 and Level 2 parameters, may filter according to the users' answers to the digital showroom questions, as delivered by the system database 652.

The provider selects the Level 1 filter parameters that coincide with the provider's research and/or marketing objectives 614. If those objectives require greater lead filtering 616, the provider proceeds to add the appropriate Level 2 filter parameters 618. If those objectives require still greater lead filtering 620, the provider proceeds to add the appropriate Level 3 filter parameters 622. When choosing from the Level 2 and/or Level 3 filtering levels, if the provider accessing the report is a specific provider, the database only delivers user data associated with the digital showroom of the provider in question. If the provider accessing the report is one from a corporate alliance, they can determine what user data will be included in the report by selecting which individual providers' digital showroom(s) will be represented. By adjusting these filtering parameters, the user can generate a virtually unlimited number of reports.

Once the provider is satisfied with the filtering parameters, they proceed to generate the report data 624.

Based on the filtering parameters across Level 1, Level 2 and/or Level 3, the report's data is retrieved from the system database, collated by the system 654, and then is displayed within a web page 626. The report includes information on specific activities performed by users within the system, such as the number of users that completed all necessary tasks in each digital showroom.

The provider then has the option 628 to save and name their selected report parameters 630 so that the filter parameters are saved in the system database for future activity 656. For example, the provider could save the report parameters, and name the saved report “Baby Boomers”.

The provider may then choose 632 to download the report data 634 in the desired file format (e.g., PDF, XML, XLS, plain text). The provider may then choose 636 to return to the main report selection screen to create other user analytics reports with different filtering, or to obtain other reports 638. The provider may also choose to exit the system.

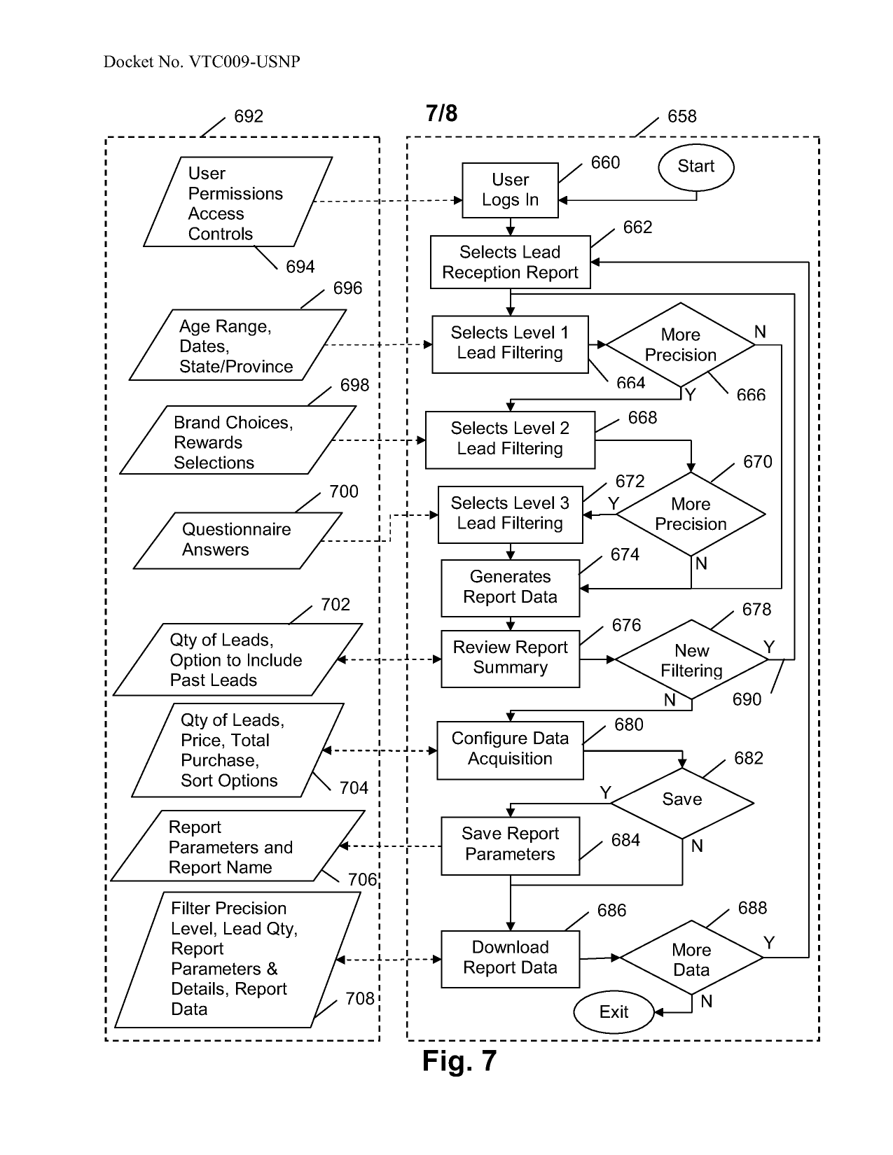

FIG. 7 shows the end-user process and data flow of an eBusiness module in the information processing engine 85 and a qualified lead reception module of the provider interface engine 87. This process results in a fourth report, beyond the three already described above. This module is not meant for use by the public. This diagram assumes that the end-user of this module is a provider, or an authorized individual of a corporate alliance of providers.

Box 658 contains the provider (or advertiser) interfaces of the eBusiness component. Box 692 contains the data stored in the database of the system software or programs coded within the system.

The provider begins by logging into the system 660. The system software detects, from the login and password that the provider has authorized access to data associated with the system and its providers 694.

The provider then selects the Qualified Lead Reception function, which ultimately generates the User Report 662. FIG. 7 illustrates the end-user flow for the Qualified Lead Reception function.

The Qualified Lead Reception function begins 664 with the first of three lead filtering levels to choose from: Level 1, Level 2 and Level 3. Each filtering level offers an increasing degree of data-filtering precision to providers, with each level representing a greater monetary investment. For example, a Level 1-filtered report may contain parameters with respect to “contact information” and “age range” for a user, as delivered by the system database 696; a Level 2-filtered report, in addition to the Level 1 filter parameters, may contain parameters with respect to a user's brand/service selections, as delivered by the system database 698; and a Level 3-filtered report, in addition to the Level 1 and Level 2 parameters, may contain a user's answers to the digital showroom questions, as delivered by the system database 700.

The provider selects the Level 1 filter parameters that coincide with the provider's research and marketing objectives 664. If those objectives require greater lead filtering 666, the provider proceeds to add the appropriate Level 2 filter parameters 668. If those objectives require still greater lead filtering 670, the provider proceeds to add the appropriate Level 3 filter parameters 672. By adjusting these filtering parameters, the provider can generate a virtually unlimited number of reports.

Once the provider is satisfied with the filtering parameters, they proceed to generate the report data 674.

The provider reviews the report summary 676, as delivered by the IT and eBusiness system 702 based on the filtering parameters across Level 1, Level 2 and/or Level 3. The report summary includes a count of the total number of matching user leads that have “opted in” to be contacted by the providers. The report summary represents the total set of data that is available for selection and purchase.

After obtaining a count for the selected lead filtering 678, the provider may then narrow down the lead quantity by strategically modifying the report through choosing new filtering parameters. For example:
Obtain “regional-based” leads by modifying Level 1 filtering to only select leads from a specific State/Province.
Obtain “brand-based” leads by modifying Level 2 filtering to only select leads that indicated a particular brand preference.
Obtain “buyer graphic-based” leads by modifying Level 3 filtering to only select leads that chose specific answers to the digital showroom questions.

Alternately, after obtaining a count for the selected lead filtering 676, the provider may then increase the lead quantity by further modifying the filter parameters and/or reducing the number of filter parameters. Any revised filter parameters are sent to the IT and eBusiness system, which provides an updated count of the total number of matching user leads that have “opted in” to be contacted by the providers. The provider reviews the new report summary 676, which indicates the matching set of user data that is available for selection and purchase. The provider may revise the search filter parameters repeatedly until they are satisfied with the filter parameters.

While viewing the report summary 676, the provider is also offered post-filtering options for reducing the number of matching leads returned by the report. These options include a “desired quantity” variable that enables the provider to manually enter a number that is less than the report's matching lead number to limit the number of leads returned while lowering the monetary investment associated with the report. An additional post-filtering option is the variable to “not include leads already represented in reports previously run” for the provider in question.

Once the provider is satisfied with the report filtering and number of matching leads, they proceed to configure the data about to be acquired 680. Data configuration options include selecting a preferred data sorting method across such parameters as “Last Name,” “Location,” “Sign Up Date/Time,” and “Last Active Date/Time.” Data configuration options also include selecting a preferred file format in which the report data will be delivered, such as XML, Tab Delimited, or Plain Text. The system then configures the report data based on the provider's configuration settings 704.

The provider then has the option 682 to save and name their selected report parameters 684 so that the combination of filter and configuration parameters are recorded by the IT and eBusiness system for future activity 706. For example, they could save the report parameters, and name the saved report “Baby Boomers”.

The provider then proceeds to download the report data 686, which sends the final selection of report parameters to the IT and eBusiness System 708, along with tracking order details, such as the cost of the report, the quantity of leads purchased, and the provider the report was run for.

The provider downloads the generated report file 686. The provider may then choose 688 to return to the main report selection screen to obtain additional lead reports 690 or exit the system.

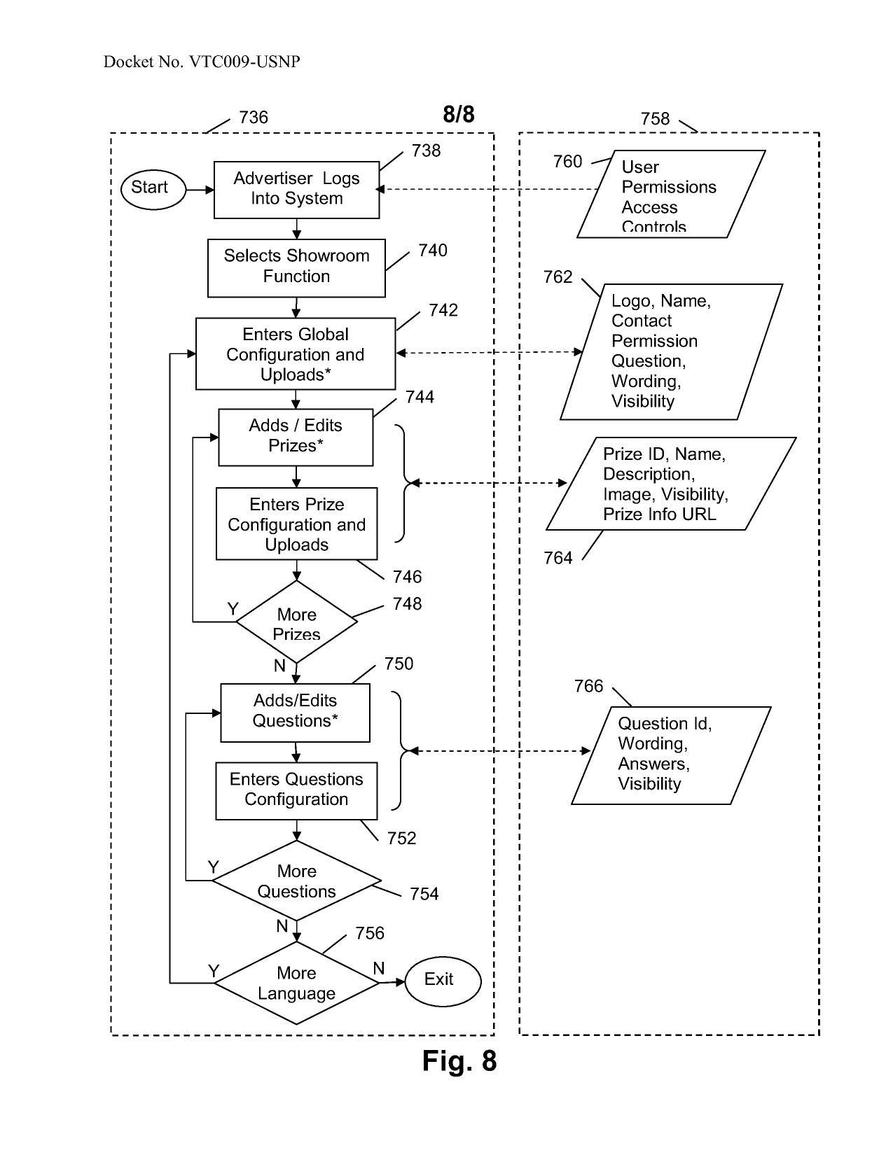

FIG. 8 shows the end user process and data flow of an provider's presentation module in the Admin Engine 93. This module is not meant for use by the public. This diagram assumes that the end-user of this module is an authorized individual of provider or corporate alliance of providers.

Box 736 contains the provider's (or advertiser's) perspective of the presentation module. Box 758 contains the data stored in the database of the system software or programs coded within the system.

The authorized provider begins by logging into the system 738. The system software detects, from the login and password that the provider has authorized access to data associated with the system and provider 760. The provider then selects the digital showroom administration function 740.

During the digital showroom administration function, the provider selects from three distinct administration functions: Global Configuration and Upload, Add/Edit Prizes, and Add/Edit Questions. These functions can be selected in any order, as noted in FIG. 8.

In the Global Configuration and Upload administration function 742, the provider enters global digital showroom data (e.g., provider name) and uploads a provider logo. The provider can also upload a new logo or edit any existing global data already stored in the system database for the given showroom. The system software saves the global data and logo in the database 762.

In the Add/Edit Prizes administration function, the provider begins 744 by adding a new prize to be displayed in the digital showroom. The system software saves a record of the new prize in the database 764. The provider can also select a prize to edit from any prize records already existing in the database which are associated with the showroom in question 744.

Once a new prize has been added or an existing prize has been selected for editing, the provider enters and configures prize information (e.g., name, description, visibility) and uploads a prize image 746. The system software saves the information and image in the database 764.

The provider then has the option 748 to add or edit more prizes.

In the Add/Edit Questions administration function, the provider begins 750 by adding a new question to be displayed in the showroom. The system software saves a record of the new question in the database 766. The provider can also select a question to edit from any question records already existing in the database which are associated with the showroom in question 766.

Once a new question has been added or an existing question has been selected for editing, the provider enters the question wording and the potential responses that may be selected when the question is being answered by users 752. The system software saves the information in the database 766.

The provider then has the option 754 to add or edit more questions.

The provider also has the option 756 to repeat any of the digital showroom administration functions as needed to support the different languages that may be required for the users.

Once the digital showroom administration process is complete, the provider can exit the system.

### V. Examples of Use

The digital marketing and revenue generation (DMRG) method and system has myriad uses; it can be used for one and/or simultaneously for a plurality of uses, including but not limited to membership, games, contests, sporting events, mobile applications, digital publications, entertainment content, and marketing, incentive and rewards-programs, Internet communities, corporate websites, voting applications, surveys, talent casting and competitions, online search, judging, elections, skill competitions, user generated video, picture and music competitions, social networks, special occasions, game shows, talk shows, traditional and new media events, traditional and new media properties, Internet and live events, digital and live concerts and festivals, special events, to name but a few. Examples of multiple usages of various embodiments listed below exploit the disclosed method and system and achieve one or more of the advantages described herein.

The disclosed digital marketing and revenue generation method and system enhances traditional and new media with an added-value application that turns both providers and users into contributors and benefactors. The method and system can be utilized by any traditional media (TV, radio, newsprint) and new media (Internet, mobile) network/company, advertising agencies and advertisers, sports franchises, to name but a few; to increase effectiveness of marketing, revenues and profitability.

The embodiments of the disclosed method and system achieve one or more of the advantages described above, in whole or in part. The list of programs that could be created with and/or benefit from the disclosed method and system is extensive; below is an example of a small fraction of possible applications, variations and uses.

### Real-World Uses

The DMRG system can be used in conjunction with any form of digital media, in any country, creating an infinite number of sponsored connectivity possibilities, including such examples as: cellular activation programs; video streaming offers; online TV show access; cable subscription offers; and social media membership and access.

The following are a few markets and examples of using the digital marketing and revenue generation system:

### Sports Industry

Fans enter a sports fantasy program to win flights, accommodations, spending money and limo rides to court side seats for the playoffs, followed by dinner and drinks with an MVP. Along the way, they choose rewards they'd like to win as they walk through showrooms sponsored, for example, by Nike, Ford, Levi's, EA and Pepsi.

### Music Industry

Music lovers enter to win tickets to a one-night performance by Lady Gaga, for example, at New York's Apollo. Winners are chosen from countries around the world while all entrants can potentially win the rewards they select in the showrooms sponsored, for example, by Coke, Virgin, Maxim, and others.

### Entertainment Programs

Instead of Oprah's “My Favorite Things” episode, where she chooses and shares her favorite things with the audience; the DMRG system may enable an “America's Favorite Things” format that transfers the ‘power to choose’ to Oprah's TV, online, and mobile audience. Viewers of the 24/7 interactive rewards and audience appreciation program may get the chance to indicate and potentially win their favorite things after walking through the showrooms of relevant sponsors.

### Online Games & Poker

Gamers may earn the opportunity to play the latest online game for free after walking through showrooms sponsored, for example, by Coke, Sony, Disney, and others. After choosing their preferred rewards, they play to win those same rewards by becoming the game's top players. Another example of an online game is an online shopping spree.

### Mobile Apps

Upon launching a new app, a mobile provider or developer may give consumers the option to either pay for it or to simply walk through showrooms that offer chances to not only receive the app for free, but also potentially win high-value rewards from related sponsors.

### Online Publications

Consumers receive a complimentary month of Cosmopolitan, for example, by walking through showrooms sponsored by L'Oreal, Prada, Rolex, and the like, or a Kindle edition of the latest Amazon travel book sponsored by Fairmont, Master Card, British Airways, and so on.

### Philanthropy & Causes

An international program to win an all expenses paid journey to the next FIFA World Cup may include among its showrooms a showcase of $10,000 “pay-it-forward” donation options that entrants choose from to benefit their favorite charity or cause.

### Online Advertising

The disclosed system can be used to counteract consumer advertisement skipping and elimination. If the provider were an advertiser and the user were a consumer, the DMRG system would ensure consumers interact one-on-one with an advertiser and its brands, products and/or service offerings in exchange for their “entry ticket.”

### Digital Showrooms

One form of the digital showrooms may display brands, products and/or services, and survey questions offered by at least one advertiser. Consumers virtually walk through a series of digital showrooms, by performing multiple tasks such as categorizing items and providing information in exchange for entry.

### Incentives and Rewards Programs

The DMRG system may be used as a standalone incentive and rewards program for both advertisers and consumers. Consumers may receive reward points for passing through the showrooms and/or entry in a random draw for a chance(s) to win one or more of their chosen goods and services.

### Christmas Promotions

By walking through the DMRG system the winner may receive a real-world visit from Saint Nick, who shows up at their home or that of a needy friend with, for example, a truckload of products and services to give-away, including the truck. A more general version of this may be an angel effect contest.

### Talk Shows

A talk show host, like David Letterman may use the DMRG system to offer a national competition such as “TOP TEN America,” to find the wittiest writers, producers and hosts. Contestants may win, for example, a grand prize package and to guest-star on The David Letterman Show.

### Casting

TV producers, such as Mark Burnett may offer a unique incentive and rewards program using the DMRG system. People could virtually walk through the showrooms to obtain an entry ticket for chances to win goods and services and land a starring role or a guest role on one of his reality shows, such as Apprentice, Survivor, etc.

### Online Video Contests

YouTube may use the DMRG system to offer an incentive and rewards entry application to online users that would like to enter a video competition and or upload videos. Users must first walk through the digital showrooms, followed by uploading a video, be it in a contest or not. The video may relate to one of the products desired to be won.

### Parallel-Running Contests

Consumers' selected prizes may optionally act as incentives to participate in one or more of a community's parallel-running contests, for example, if such contests are set up. In addition to an online video contest, consumers may earn entries into a second type of contest where they view, review, judge, vote for and/or rate content submitted for entry into the community's video contest.

### Multi-Brand Niche Communities

The DMRG system may create independent multi-brand communities, which provide stand-alone economies in which the system operates. Advertisers and consumers are the stakeholders of a given community's economy; together they physically supply its materials and labor force as well as create its entertainment properties and market its domain. By inviting other consumers to join a community, contestants may create a self-sustaining system that may grow exponentially. Viral marketing may occur as consumers that have been entertained by a community's content send invitations to other consumers via the community's social networking and/or micro-blogging applications, word-of-mouth, social networking, other electronic means, and/or any other form of communication.

### VI. Variations of Embodiments

The variations of embodiments listed below may be utilized by myriad corporations, organizations and people, nationally and internationally, by one and/or simultaneously by a plurality of users, including: advertising agencies, advertisers, traditional media, television, radio, newsprint and new media, Internet, mobile and satellite networks, sponsorship marketing, product placement, film, charities, music and concert promoters, individual sports teams, sports franchises, Olympic committees, to name but a few.

### Pay for Precision, Preference, Permission and Performance (P5) Marketing

P5 Marketing enables advertisers to pay for the data collected according to its quantity and quality. For example, permission given by a consumer to be called by the advertiser would be worth more than permission given to be emailed. The method and system is a turn-key software application, or software as a service (SaaS) for international licensing. As a result, the advertisers' marketing efforts can be highly focused and tailored towards the most receptive consumers.

### Corporate Sponsorship

The DMRG system may be set up as a comprehensive corporate sponsorship application that is packaged as a complete marketing program that can be licensed. Corporations and organizations that could exploit this include advertising agencies, advertisers, traditional and new media companies, sponsorship marketing organizations, charities, concert promoters, sports franchises, Olympic committees, to name but a few. Multiple industry-exclusive corporate sponsors may license the program and display their brands, products and/or services in the digital showrooms.

### Product Placement

The method and system relate to a marketing integration of a brand, product and/or service in one or a plurality of the following: entertainment program, game, contest, membership, incentive and rewards program, mobile application or mobile content, traditional and new media program and/or event and/or Internet domain, portal or community, to name but a few. The method and system is packaged as a product placement marketing application.

### Surveys and Research

The method and system offer a comprehensive precision and performance-based research application that generates revenues and is related to electronic surveys and in-depth consumer research. The method and system contain one or more of the following: real-time consumer-intelligence, consumer profiling and qualified lead generation, and questions may or may not be related to the products in the digital showrooms. The method and system's data is generated by individual consumers.

### Leveraged Marketing

The method and system relate to leveraged marketing where a plurality of industry-exclusive advertisers or corporate sponsors form an alliance, pooling portions and/or entire advertising budgets for a particular time period and/or marketing mandate to participate in a mutually beneficial interactive marketing campaign. The method and system maintains each advertiser's brand marketing autonomy while providing several times the efficiency and one-on-one interactive consumer/brand engagement than provided by traditional advertising and marketing practices, at a fraction of the cost.

### Consumer Intelligence in Exchange for a Reward Incentive

The method and system offers the option of offering individual consumers the chance to gain extra value, entries, bonuses, etc. by answering optional consumer intelligence questions relating to the providers' brands, products and/or services once they have already passed through the showroom(s) and have been granted entry to the system. In such cases, it could be that none, one or some of the showrooms require answering consumer intelligence questions before entry to the system is granted. The consumers' answers are collected and categorized to provide the provider with valuable consumer intelligence information.

For example, referring back to FIG. 5, step 166 in which predefined questions are answered may be omitted on passing through the digital showrooms. Likewise, step 186 in which the answers and permissions are collected would also be omitted. The consumers may then return later to the showrooms to answer the questions, for example, after they have viewed a video clip, show or other performance. Data based on preferred prize choices would still be collected and would still have value to the providers, even if it is from consumers who did not return to the showrooms.

### Preference Data by Prize Customization

The questions and/or choices presented in the showrooms may be such that consumers indirectly provide their preferences to the system. For example, if the prize is a certain model of car, it may be displayed in several different colors. By making their prize selection, users are inherently making their preferred choice of color known. This information may then be supplied to the providers. They may be able to select a model of a car, select which option(s) they prefer, and then choose a color. Users may also be given the chance to define their own color. This principle may be extended to cover many other optional features of other products, such as household appliances, furniture, clothing, bicycles, skateboards, electronic devices, holidays, menus, etc.

### Other Variations

These include the incorporation of the DMRG system into brand entertainment, where branded items and/or services are the primary props; the use of it in interactive TV; its use on a global scale as well as a national scale; its use in theme celebrations; its parallel use in different types of media such as TV, print, radio, internet, mobile devices etc; and embedding it an a social network.

Other examples of types of contest to which the DMRG system may provide entry include most valuable sports fan, real life shopping spree, and becoming an Oscar judge.

The DMRG system may be easily adapted to suit any advertisers' needs while providing meaningful and relevant content and activities that consumers actually want to engage, absorb, enjoy and retain as part of their virtual and real-life experiences. Many other variations are also possible without departing from the scope of the claimed invention.

What is claimed is:

1. A method of administering over a network of processing and communication devices exchanges of work for items and benefits, comprising:
(a) presenting by a processor an assortment of items offered by at least one provider;
(b) receiving by the processor a respective body of work performed by each of a plurality of workers, each respective body of work comprising an item choice selection;
(c) granting, by the processor, a benefit to each of the plurality of workers;
(d) presenting by the processor an assortment of received work to the at least one provider; and
(e) awarding to at least one of the plurality of workers, in response to his respective body of work, a selection of items corresponding to his respective choice.

2. A method according to claim 1 wherein the processor determines which of the plurality of workers is to be awarded a selection of items.

3. A method according to claim 2 wherein the processor determines by
carrying out a random draw,
adding up ratings for each worker's respective body of work, or
counting votes for each worker's respective body of work.

4. A method according to claim 1 wherein the benefit is one or more of entry in a contest, entry in prize draw, entry in a game, entry to a sports fantasy program, entry to a stock dealing fantasy program, entry to a club, membership of a community, admission to a show, admission to a concert, membership of an audience, a free download of music, a free download of an app, a free download of video, a printed publication, a coupon, one or more reward points, access to an online TV show, access to digital content, a discount, a password, a gift, a surprise gift, an improved rating, one or more reputation points, a cellular activation, cellular airtime, free communications bandwidth, a cable subscription, air miles, an increased chance in a prize draw, and a sum of money.

5. A method of administering over a network of processing and communication devices exchanges of work for items and entry, comprising:
(a) presenting by a processor an assortment of items offered by a plurality of providers;
(b) receiving by the processor a respective body of work performed by each of a plurality of workers, each respective body of work comprising an item choice selection;
(c) granting, by the processor, entry to each of the plurality of workers;
(d) presenting by the processor an assortment of received work to at least one of the providers; and
(e) awarding to at least one of the plurality of workers, in response to his respective body of work, a selection of items corresponding to his respective choice.

6. A method of administering over a network of computing and communication devices exchanges of work for prizes, comprising:
(a) presenting by one or more of said devices an assortment of prizes offered by at least one sponsor;
(b) presenting by one or more of said devices an assortment of work of value to the at least one sponsor;
(c) receiving by one or more of said devices a respective prize choice selection from each of a plurality of workers;
(d) receiving by one or more of said devices a respective body of work performed by each of the plurality of workers; and
(e) awarding to at least one of the plurality of workers, in response to his respective body of work, a selection of prizes corresponding to his respective choice.

7. A method as claimed in claim 6, wherein
presenting an assortment of prizes includes presenting an assortment of sets of prizes, and
receiving a respective prize choice selection includes receiving a respective prize choice selection that selects one prize from each set.

8. A method as claimed in claim 6, wherein presenting an assortment of prizes includes at least one of
presenting at least one of the assortment of prizes in a virtual showroom,
presenting at least one of the assortment of prizes as a prop in an interactive entertainment,
presenting at least one of the assortment of prizes as an element for inclusion in user-generated-content
presenting at least one of the assortment of prizes as a focus in at least one special event,
presenting at least one of the assortment of prizes in association with a series highlight, and
presenting at least one of the assortment of prizes in a printed publication.

9. A method as claimed in claim 6, further comprising categorizing the bodies of work.

10. A method as claimed in claim 9, further comprising providing a categorized body of work to the at least one sponsor.

11. A method as claimed in claim 10, wherein providing a categorized body of work to the at least one sponsor includes obtaining remuneration from the at least one sponsor.

12. A method as claimed in claim 11, wherein the remuneration is a function of at least one of
the precision of the categorized body of work,
the degree to which the categorized body of work includes purchasing preferences,
the degree to which the categorized body of work includes permission for the sponsor to interact with the categorized plurality of workers, and
the actual performance of sales to the categorized plurality of workers.

13. A system for administering exchanges of work for prizes comprising:
a computer-readable medium;
a processor in a server;
a plurality of computing and communication devices connected via a network to said server; and
computer-readable instructions residing in said computer readable medium for processing by said processor, the system being configured to
(a) present by the processor an assortment of prizes offered by at least one sponsor,
(b) present by the processor an assortment of work of value to the at least one sponsor,
(c) accept by the processor a respective prize choice selection from each of a plurality of workers,
(d) accept by the processor a respective body of work performed by each of the plurality of workers, and
(e) determine at least one of the plurality of workers to be awarded, in response to his respective body of work, a selection of prizes corresponding to his respective choice.

14. A system as claimed in claim 13, further configured to categorize the bodies of work.

15. A system as claimed in claim 13, wherein
an assortment of prizes includes an assortment of sets of prizes, and
a respective prize choice selection includes a respective prize choice selection that selects one prize from each set.

16. A system as claimed in claim 15, further configured to present at least one of an assortment of prizes and an assortment of work in association with corporate assets.

17. A system as claimed in claim 16, wherein corporate assets include indicators of brand.

18. A system as claimed in claim 13, wherein the assortment of work includes the provision of information.

19. A system as claimed in claim 18, wherein information includes
personal information, and
a license for the personal information.

20. A system as claimed in claim 19, wherein a license includes a grant of permission to be contacted.

21. A system as claimed in claim 15, wherein the system is further configured to
present at least one of the assortment of prizes in a virtual showroom
present at least one of the assortment of prizes as a prop in an interactive entertainment
present at least one of the assortment of prizes as an element for inclusion in user-generated-content,
present at least one of the assortment of prizes as a focus in at least one special event,
present at least one of the assortment of prizes in association with a series highlight, and
present at least one of the assortment of prizes in a printed publication.

22. A system as claimed in claim 21, further configured to present at least one of the assortment of prizes in association with a scenario that is affected by the at least one of the assortment of prizes.

23. A system as claimed in claim 22, wherein the scenario includes at least one of
a plot,
a contest,
a choice of contests,
a real-life situation,
an event, and
a challenge

24. A system as claimed in claim 23, further configured to provide a categorized body of work to the at least one sponsor.

25. A system as claimed in claim 24, further configured to obtain remuneration from the at least one sponsor.

26. A system as claimed in claim 25, wherein the remuneration is a function of at least one of
the precision of the categorized body of work,
the degree to which the categorized body of work includes purchasing preferences,
the degree to which the categorized body of work includes permission for the sponsor to interact with the categorized plurality of workers, and
the actual performance of sales to the categorized plurality of workers.

27. A system for publicizing sponsorship of an event comprising:
a computer-readable medium;
a processor in a server;
a plurality of remote terminals connected via the internet to said server; and
computer-readable instructions residing in said computer readable medium for processing by said processor, the processor being configured to
(a) display information relating to a plurality of sets of items on a remote terminal, each set offered by a different provider;
(b) accept a plurality of first inputs from said remote terminal, each first input representing a selection of an item from each of the sets;
(c) display on said remote terminal, for each of the sets, one or more questions relating to the items in the set;
(d) accept from said remote terminal, for each of the sets, one or more second inputs representing responses to said questions relating to the items in the set;
(e) define the selected items as a prize package conditional upon receiving a second response for each of the sets;
(f) for each set, transmit information representative of said second inputs to the provider of the set;
(g) accept from said remote terminal an input from a user representing permission to be contacted by a first provider;
(h) transmit sufficient information to said first provider to enable said first provider to contact said user; and
(i) accept an input from said user representing an interest to receive a benefit related to said event.

28. A system as in claim 27 wherein at least one provider is a sponsor of said event.

29. A system for administering exchanges of work for prizes comprising:
a processor; and
a plurality of terminals connected to the processor, the processor configured to:
(a) present via the plurality terminals at least one prize offered by an provider;
(b) accept via each terminal a respective body of work each performed by one of a plurality of workers;
(c) categorize the bodies of work into categories of different value;
(d) provide one or more categorized bodies of work to the provider;
(e) receive from the provider a commitment to pay an amount depending on the value of each categorized body of work provided; and
(f) determine at least one of the plurality of workers to be awarded the prize.

30. A system for administering exchanges of work for predetermined benefits comprising:
a processor; and
a plurality of terminals connected to the processor, the processor configured to:
(a) present via the plurality terminals an opportunity to work for a provider;
(b) accept via each terminal a respective body of work each performed by one of a plurality of workers;
(c) grant each worker a predetermined benefit;
(d) categorize the bodies of work into categories of different value;
(e) provide one or more categorized bodies of work to the provider; and
(f) receive from the provider a commitment to pay an amount depending on the value of each categorized body of work provided.

31. A system as in claim 30 wherein the predetermined benefit is independent of the category of the respective body of work.

32. A mobile processing and communication device for exchanging work for items and benefits, the device comprising:
a processor;
a display; and
an input interface, the processor configured to:
(a) present via the display an assortment of items offered by at least one provider;
(b) receive, via the interface, work of value to the at least one provider, said work comprising an item choice selection;
(c) transmit the work to a further, remote processor for storage in a computer readable medium;
(d) receive a benefit or access to a benefit; and
(e) receive confirmation of a chance to win a selection of items corresponding to said item choice selection.
